(19) United States
(12) Patent Application Publication
(10) Pub. No.: US 2004/0139836 A1
(43) Pub. Date: Jul. 22, 2004

(54) Narrow profile fiddle or violin and carrying case and method of making same

(76) Inventor: Bill Whipple, Union, WV (US)

Correspondence Address: Todd S. Parkhurst, Holland & Knight LLC, Suite 800, 55 West Monroe Street, Chicago, IL, 60603-5144, US

(21) Appl. No.: 10/345,644

(22) Filed: Jan. 16, 2003

(51) Int. Cl. G10D 1/02

(52) U.S. Cl. 84/274

(57) ABSTRACT

A musical violin or fiddle and a carrying case are provided. The fiddle has a restricted or narrow profile so as to permit the fiddle to be fit within the carrying case. The carrying case is made from a polyvinyl chloride pipe length preferably having an internal diameter of not greater than two inches.

This invention relates generally to violins or musical fiddles, and more particularly concerns a fiddle of narrow profile or restricted body width and a carrying case for the fiddle. The carrying case is formed of a length of cylindrical pipe, such as polyvinyl chloride pipe, which is of a predetermined inner diameter and length.

It is an object of the present invention to provide a violin or musical fiddle which has a pleasing musical sound when it is played, and yet which is of narrow profile or restricted width so that it can be stored within a relatively narrow carrying case. An associated object is to provide such a carrying case which is preferably made of polyvinyl chloride pipe of predetermined inner diameter and length.

It is another object of the invention to provide such a violin or musical fiddle which can be manufactured relatively easily and inexpensively by woodworkers and violin makers of moderate skill and experience.

Other objects and advantages of the invention will become apparent upon reading the following detailed description and upon reference to the drawings. Throughout the drawings, like reference numerals refer to like parts.

### BRIEF DESCRIPTION OF THE DRAWINGS

FIG. 1 is a plan view of the novel fiddle.

FIG. 2 is a side elevational view of the novel fiddle.

FIG. 3 is a sectional view of the fiddle and carrying case taken substantially in the plane of line 3-3 in FIG. 2.

### DETAILED DESCRIPTION

While the invention will be described in connection with a preferred embodiment and procedure, it will be understood that it is not intended to limit the invention to this embodiment or procedure. On the contrary, it is intended to cover all alternatives, modifications and equivalent as may be included width the spirit and scope of the invention as defined by the appended claims.

A violin or fiddle is provided which will fit inside a 24″ length of 2″ diameter thin wall PVC pipe with a bow and chinrest for easy and safe travel.

In accordance with one aspect of the invention, manufacture of the fiddle 10 can be accomplished by a woodworker or violin maker of moderate skill and experience. On a lathe the maker turns a piece of maple 2″ by 2″ by 21″ until it is a round cylinder, preferably a right cylinder, and preferably 1⅞ inches in diameter.

Maple wood, properly as dried and cured, has long been favored for fiddle and violin bodies. At a distance 340 mm from the butt end 12 the maker further turns the wood so that the vessel narrows to 32 mm in diameter; and at 450 mm from the butt he or she further turns and reduce the diameter of the wood to 26 mm. This will be the neck 14. He or she then divides the turned wood piece lengthwise along a diametrically oriented plane to form two long half round pieces.

These two long half round pieces can be used to make two separate violins.

The wood 16 adjacent long butt end 12 is then carved out with a router or other suitable device or tool beginning at a position 18 located 10 mm from where the body narrows for the neck to a point located 5 mm from the butt end 12. The carving or routing is performed so that the remaining walls are 3 mm thick. This is the sound cavity.

A flat piece 20 of ¼ sawn spruce 2.4 mm thick is glued on top of the open cavity. Spruce wood, properly as dried and cured, has long been favored for violin and fiddle body tops.

Sound holes 22 are cut out of the spruce top at positions above and below the location where the bridge is to be mounted. The nut 24, saddle 26, and fingerboard 28 are mounted on the instrument 10.

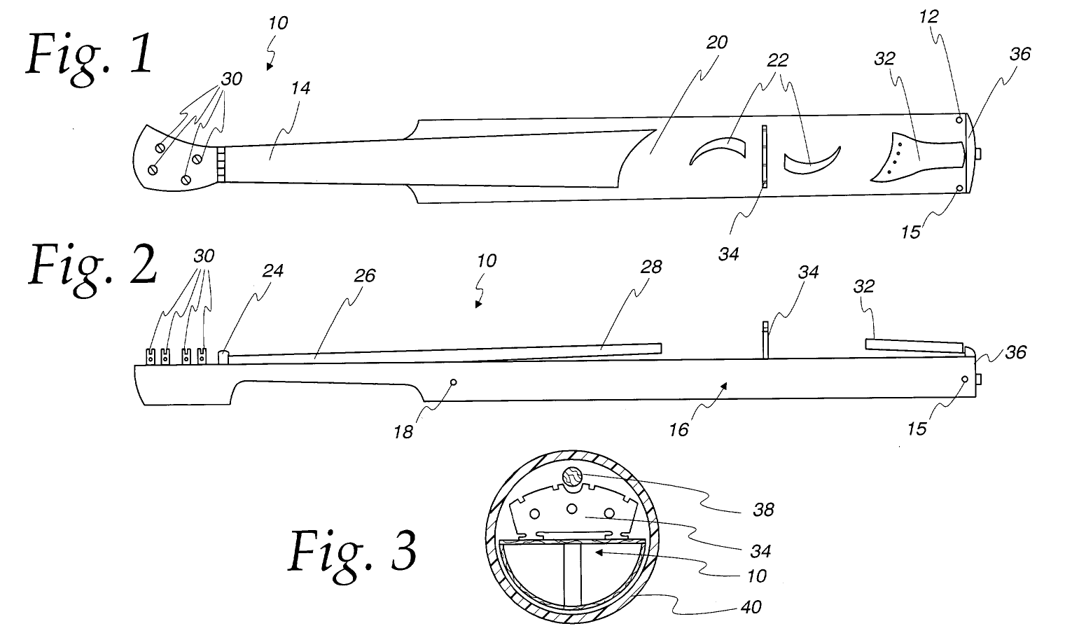

Tuners 30 can be 3/16″ metal dowel with fine threads cut on the bottom half of a dowel so as to adapt them to be screwed into the headstock. The top half of each tuner 30 is provided with a 1/16″ hole for the string and a 1/16″ slot cut 1/16″ deep in its top to accommodate a penny to be used as a tuning key. A tail piece 32 is attached near the butt 12, and a bridge 34 is attached as shown in FIGS. 1 and 7.

The fiddle is then varnished. Many violin varnishes are compounds of near-mythical trade secrecy, but one oil-based violin varnish, and a process for applying it, are disclosed in U.S. Pat. No. 5,018,422, incorporated herein by reference. Elevated heat and pressure are not necessarily required in applying varnish to the fiddle or violin of the present invention.

A chinrest 36 is formed from a 235 mm length of bicycle inner tube connected at the ends like a doughnut. That portion of the inner tube which is provided with a valve is utilized so it can be inflated by the user. This inflatable chin rest will slide on the butt of the instrument during use of instrument and will be removed and stored in the case when not in use.

A violin bow 38 known design and construction can be used to play the instrument.

A carrying case 40 can be formed of any convenient hollow cylindrical object. Preferably, a 24 inch length of polyvinyl chloride pipe having an internal diameter of two inches or more can be used. The interior of this pipe/carrying case can be lined with a fabric or other material, if desired, to preserve the surface finish of the fiddle and bow. The ends of the pipe/carrying case can be fitted with caps of known design to enclose and securely maintain the fiddle 10 and bow 38.

I claim:

1. A musical violin shaped and sized to fit inside a two inch diameter cylinder.

2. A musical violin according to claim 1 wherein said violin includes a body, a neck, a head stock, a bridge, and a tailpiece.

3. A musical violin according to claim 1 wherein said violin includes a chin rest.

4. A musical violin according to claim 3 wherein said chin rest is formed from a bicycle tire inner tube.

5. The combination of a musical violin and a carrying case, the carrying case being made from a polyvinyl chloride pipe.

6. The combination according to claim 5 wherein said pipe has an inner diameter of not more than two inches, and wherein said musical violin fits inside entirely inside said pipe.

7. The combination according to claim 5 further including a bow to be used for playing the violin, and wherein both the bow and the violin together fit entirely inside said pipe carrying case.

8. The combination according to claim 5 wherein said pipe carrying case is not more than 24 inches in axial length.

9. A method of making a musical stringed instrument violin comprising the steps of
forming a piece of wood into a cylinder;
dividing the wood lengthwise along a diametrically oriented plane to form two half round pieces,
carving out the interior of at least one of the pieces; and
gluing a substantially flat piece of wood atop the carved-out cavity.

10. A method according to claim 9 wherein the step of forming the wood into a cylinder includes the step of turning the wood on a lathe.

11. A method according to claim 10 wherein the step of turning the wood includes the step of forming the wood into a cylinder having a maximum diameter of substantially 1⅞ inches.

12. A method according to claim 11 further including the step of turning the wood cylinder over a portion of its length to a maximum diameter of substantially 32 mm.
